(19) United States
(12) Patent Application Publication
(10) Pub. No.: US 2012/0019974 A1
(43) Pub. Date: Jan. 26, 2012

(54) PROCEDURE FOR ACCUMULATION AND DISTRIBUTION OF LIGHTNING ELECTRICAL ENERGY

(76) Inventor: Robert Rener, Brcko distrikt BiH (BA)

(21) Appl. No.: 13/257,624

(22) PCT Filed: Mar. 18, 2010
(86) PCT No.: PCT/BA2010/000001

§ 371 Date: Sep. 20, 2011

(30) Foreign Application Priority Data
Mar. 24, 2009 (BA) BAP092706A

(51) Int. Cl. H05F 3/02

(52) U.S. Cl. 361/222

(57) ABSTRACT

Accumulation off the electrical energy, using tank LC circuit combined with crystal oscillator. Source of induction for initial accumulation, comes from magnetic field in the lightning rod during the lightning strike. Accumulated energy can be used in the existing grid or as electrical energy source.

### TECHNICAL FIELD

This invention refers to electrical field, procedure for accumulation of the electrical energy. According to international patent classification IPC, this invention is classified under H 02 J CIRCUIT ARRANGEMENTS OR SYSTEMS FOR SUPPLYING OR DISTRIBUTING ELECTRIC POWER; SYSTEMS FOR STORING ELECTRIC ENERGY”.

### TECHNICAL PROBLEM

Problems that production and distribution of electrical energy at present are side effects such as nuclear waste, polluted environment, bad chemical substances, destruction of animal habitats, and accumulation and production on behalf nature is not economical for it's produces small amounts of electrical energy.

### BACKGROUND ART

There are many ways to produce and accumulate electrical energy in today's state of the, art. Accumulation mostly refers to galvanic elements that by chemical reaction produce electrical energy, known as batteries. Production of electrical energy is happening trough transforming different energy's into electrical. So we have “Hydro-plants” that transforms running water energy into electrical; “Thermo-plants” transforms thermo dynamical energy of burning fossil fuels into electrical energy; “Nuclear plants” transforms energy form braking an atom into electrical energy “Wind plants” transforms wind energy into electrical; “Gas-plants” that using burning gases transforms into electrical energy; Solar cells that transforms sun light energy into electrical. There are some technical solutions to transform earth gravity energy into electrical, but this solution is not in use. It is interesting that the biggest pollution sources are producing the largest amounts of electrical energy. So nuclear plants are the strongest ones, than comes thermo plants, hydro plants, wind plants and at the end batteries.

### DISCLOSURE OF THE INVENTION

FIG. 1.

Lightning rod (1) must be Franklin like, since for this purpose magnetic field (2) surrounding the lightning rod is wanted.

After lightning discharge, the magnetic field surrounding the lightning rod will induct electrical energy in the inductor (3) which cuts magnetic Field.

A capacitor (4) stores energy in the electric field between its plates, depending on the voltage across it, and an inductor stores energy in its magnetic field, depending on the current through it. Since a charged capacitor is connected across an inductor, charge, will start to flow through the inductor, building up a magnetic field around it, and reducing the voltage on the capacitor. Eventually all the charge on the capacitor will be gone. However; the current will continue, because inductors resist changes in current, and energy will be extracted from the magnetic field to keep it flowing. The current will begin to charge the capacitor with a voltage of opposite polarity to its original charge. When the magnetic field is completely dissipated the current will stop and the charge will again be stored in the capacitor (with the opposite polarity) and the cycle will begin again, with the current in the opposite direction. The charge flows back and forth between the plates of the capacitor, through the inductor. The energy oscillates back and forth between the capacitor and the inductor until internal resistance makes the oscillations die out.

To avoid drain out, restoring the loses is done by placing the crystal oscillator (5) in the circuit.

The crystal oscillator circuit sustains oscillation by taking a voltage signal from the quartz resonator, amplifying it, and feeding it back to the resonator. The rate of expansion and contraction of the quartz is the resonant frequency (6), and is determined by the cut and size of the crystal. When the energy of the generated output frequencies matches the losses in the circuit, an oscillation can be sustained (7).

Connecting inductors in series (L+L2+ . . . Ln) and capacitors in parallel (C1+C2+C3+ . . . Cn), this circuit can be increased in order to increase the amount off energy that can be accumulated, eventually meeting the lightning energy (8).

FIG. 2.

To connect this circuit to the Grid, it needs to oscillate at 50/60 Hz. frequency off the Grid (9). From the basic resonant frequency formula, the L and C values determine the frequency of resonance. Various combinations of L and C can be resonant at one particular frequency (10), in this case 50/60 Hz. However, the crystal oscillator at 50/60 Hz has not been produced yet, so for the time being, this works only in theory.

### SHORT DESCRIPTION OF THE DRAWINGS

Drawings that are included in this description and that make part of the description of invention are illustrating the best way to conduct this invention, and are helping to explain basic principles of the invention.

FIG. 1 gives description off the invention.

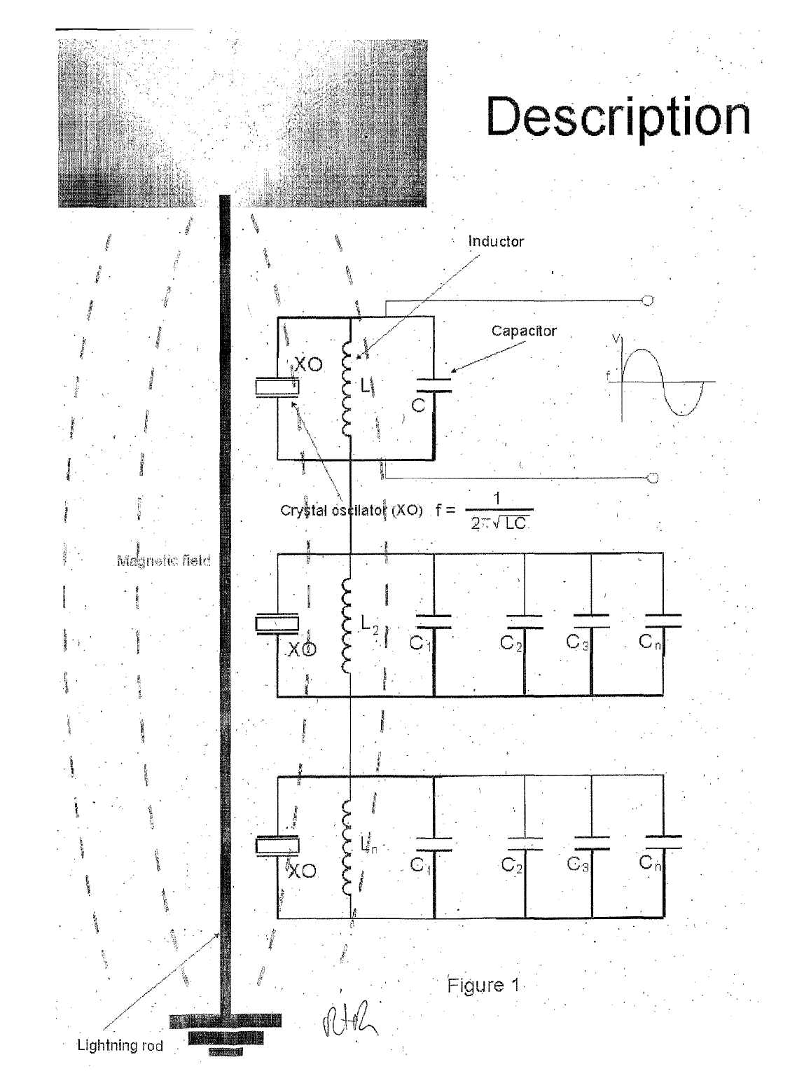

FIG. 2 shows way to connect to the Grid.

### DETAIL DESCRIPTION OF AT LAST ONE OF THE METHOD OF REALISATION OF THE INVENTION

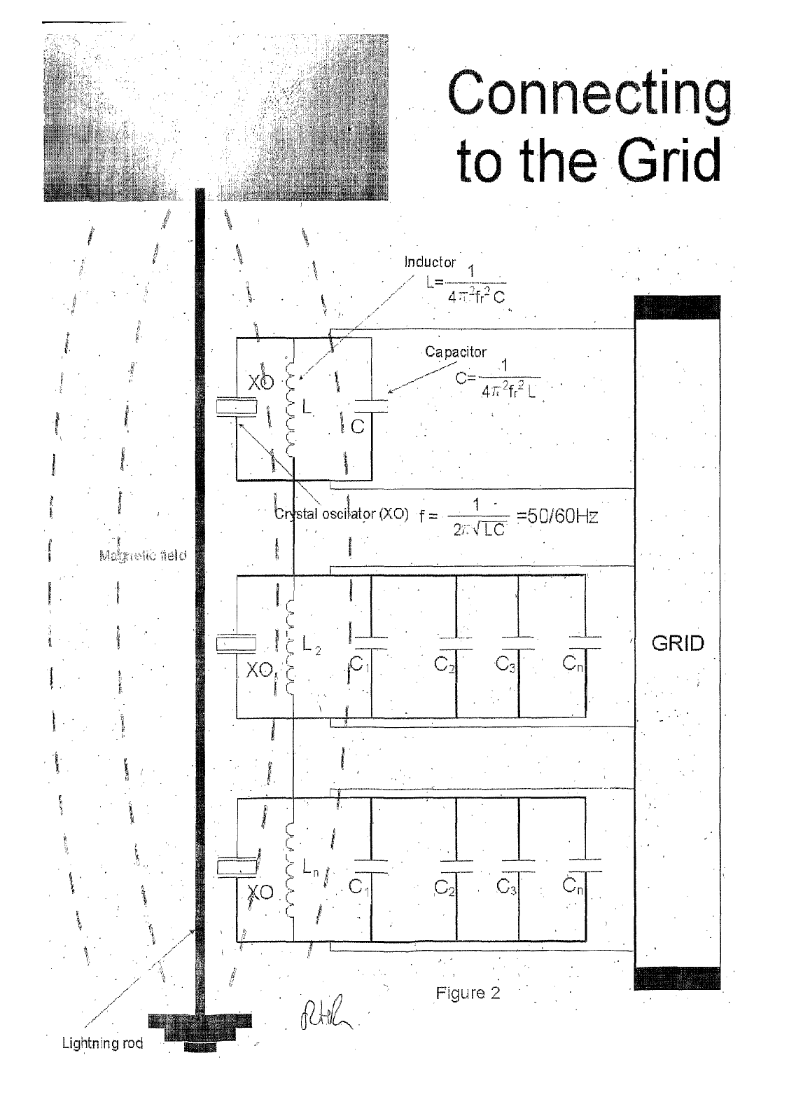

Referring to FIG. 2, we see that electrical energy accumulated in the circuit (described on the disclosure off the invention) that oscillates on the frequency off the grid (50/60 Hz) can be connected to the grid. After every new lightning strike trough the lightning rod, electrical circuit that energizes the grid is recharged. This way we use naturally renewable electrical energy.

### METHOD OF APPLICATION OF INVENTION

Invention can be applied where thunders strikes. Limiting factor is fact that components needed are being produced at too small scale to satisfy possibilities that this invention offers. This opens a new chapter in manufacturing large capacitors, inductors and crystal oscillators, since market had no demand for these types off the components by now. And who, knows where exploration for ways to produce more efficient components in large scale will take us.

1. Procedure for accumulation and distribution off lightning electrical energy characterized by is made off parallel connection off crystal-oscillators, inductors and capacitors, that are in scale so they can accumulate electrical charge, whose amount depends on the size off the components, and serve to accumulate electrical energy that is present during lightning strike at the lightning rod designed so that gives as largest magnetic field in the moment off lightning strike, moreover inductor off electrical circuit for accumulation cutes magnetic field of the lightning rod and so accepts first charge, moreover multiple capacitors are connected in parallel, and multiple inductors are connected in series so electrical circuit can be increased and more electrical energy can be accumulated, therefore energy off the lightning.

2. Electrical circuit from claim 1 characterized by is used in scale where individual electrical circuits are oscillating at the frequency 50 Hz or 60 Hz, and those circuits are energizing existing grid.
